(19) United States
(12) Patent Application Publication
(10) Pub. No.: US 2015/0086728 A1
(43) Pub. Date: Mar. 26, 2015

(54) MACHINING SYSTEM AND METHOD FOR MACHINING MICROSTRUCTURE ON LIGHT GUIDE PLATE

(71) Applicant: HON HAI PRECISION INDUSTRY CO., LTD., New Taipei (TW)

(72) Inventor: PO-CHOU CHEN, Tu-Cheng (TW)

(21) Appl. No.: 14/490,021

(22) Filed: Sep. 18, 2014

(30) Foreign Application Priority Data
Sep. 25, 2013 (TW) 102134626

(51) Int. Cl. B29D 11/00; B29C 67/00

(52) U.S. Cl. CPC B29D 11/00875; B29C 67/0055; B29C 67/0088; B29C 67/0085; B29C 2791/001; B29C 2795/00; B29K 2101/12
USPC 427/553; 427/162; 118/696

(57) ABSTRACT

A light guide plate includes a first transparent base layer, an adhesive layer and a transparent composite layer. The adhesive layer is configured for bonding the transparent composite layer on the first transparent base layer. The transparent composite layer is located on the adhesive layer, and the transparent composite layer comprising a light emitting surface, the light emitting surface includes a plurality of microstructures.

### FIELD

The subject matter herein generally relates to a machining system for machining microstructures on a light guide plate, and a method for manufacturing microstructures on light guide plates.

### BACKGROUND

Generally, a light guide plate includes a light output surface and microstructures are formed on the light output surface of the light guide plate to increase utilization efficiency of the light rays. Thus, microstructures on the light guide plate are very important for redirecting the light rays.

### BRIEF DESCRIPTION OF THE DRAWINGS

Implementations of the present technology will now be described, by way of example only, with reference to the attached figures, wherein:

FIG. 1 is a diagrammatic view of a machining system including a platform and a controller, in accordance with an example embodiment.

FIG. 2 is a diagrammatic view, showing a light guide plate placed on the platform of the machining system of FIG. 1.

FIG. 3 is a diagrammatic view, showing that a three-dimensional (3D) model of microstructures is established on the light guide plate of FIG. 2 by the controller of FIG. 1.

FIG. 4 is a diagrammatic view, showing that the machining system of FIG. 1 machines microstructures on the light guide plate.

FIG. 5 is a diagrammatic view of a light guide plate with microstructures.

FIG. 6 is a flow chart of an example method for machining microstructures on a light guide plate.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like. The references “a plurality of” and “a number of” mean “at least two.”

The disclosure is described in relation to a machining system for machining microstructure on a light guide plate. The machining system comprising: a platform configured for supporting a light guide plate; a controller configured for establishing a 3D model for microstructures on the light guide plate; a driving device is configured for moving three-dimensionally and electrically connecting with the controller; a 3D printer is fixed on the driving device, and driven by the driving device, the 3D printer is configured for accommodating material and configured for printing microstructures on the light guide plate according to the 3D model; and at least one solidifying device is arranged on the driving device and configured for solidifying the material injected by the 3D printer.

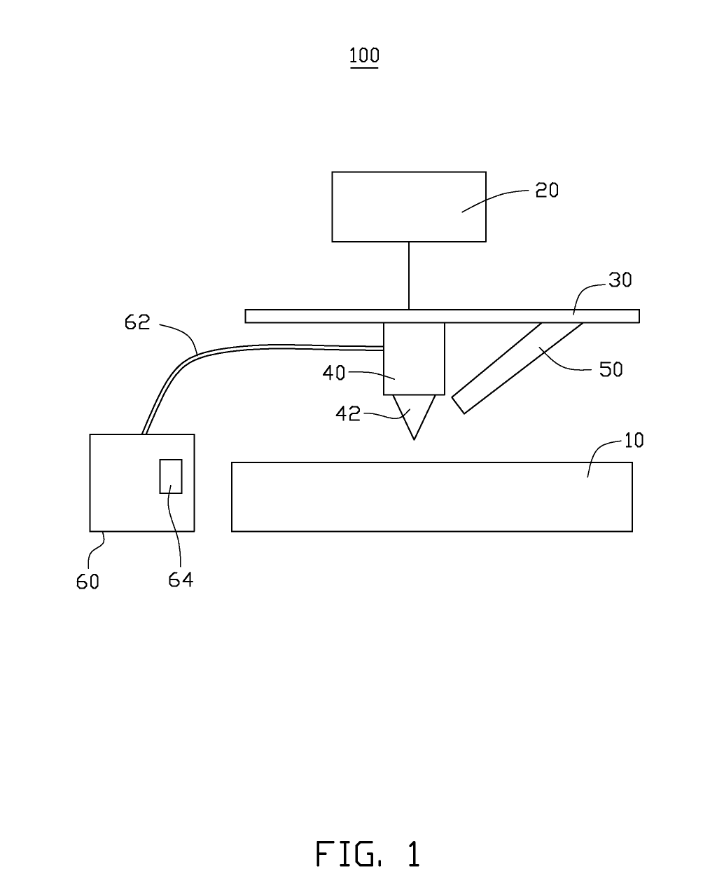

FIG. 1 shows a machining system 100 according to one embodiment. The machining system 100 is used for machining microstructures on a light guide plate 200. The machining system 100 includes a platform 10, a controller 20, a driving device 30, a 3D printer 40, at least one solidifying device 50, and a container 60.

The platform 10 is configured for supporting the light guide plate 200.

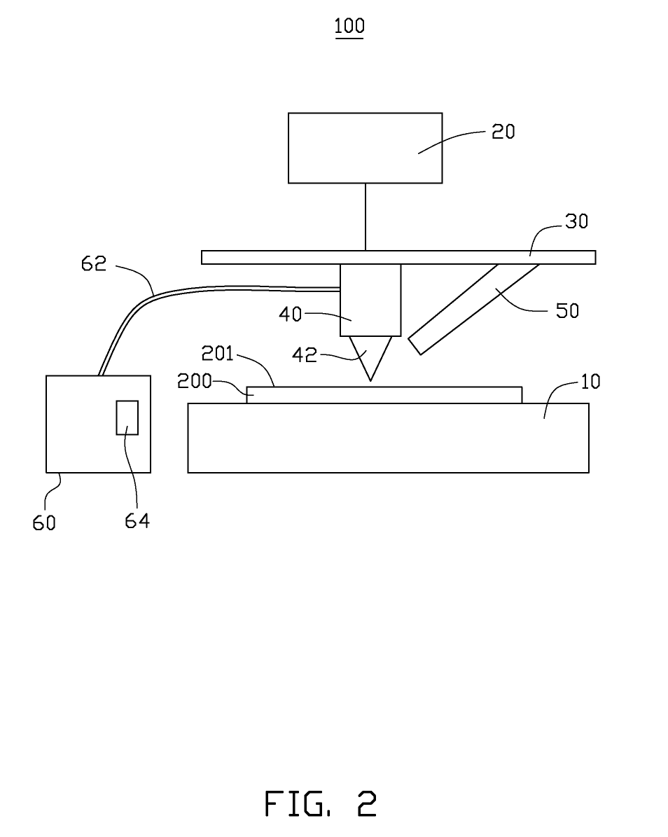

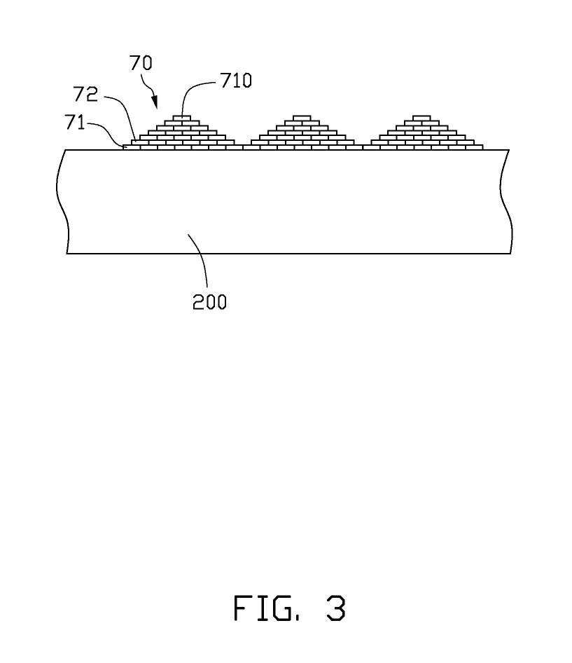

FIGS. 2-3 illustrate that the controller 20 is configured for establishing a 3D model 70 on the light guide plate 200. In the illustrated embodiment, the controller 20 is a computer. A shape of the 3D model 70 is the same as a shape of the microstructures 300 formed on the light guide plate 200. Aided design software, such as auto CAD, is loaded in the controller 20 to establish the 3D model 70. The controller 20 is also configured for dividing the 3D model 70 into a plurality of layers, for example, layers 71, 72 and so on, stacked alternatively on each other, and for capturing a location data of each layer of the 3D model 70, and for sending the location data to the driving device 30. In the illustrated embodiment, the location data is 3D coordinates. In the illustrated embodiment, each of the layers 71 and 72 is further divided into a plurality of segments 710 by the controller 20.

The driving device 30 is electrically connected with the controller 20.

The 3D printer 40 is fixed on the driving device 30 and is driven by the driving device 30 to move in 3D space. The 3D printer 40 is configured for accommodating material and printing microstructures on the light guide plate 200 according to the 3D model. The 3D printer 40 comprises a printing head 42 in a vertical direction. Material for forming the microstructures 300 is injected from the printing head 42.

The at least one solidifying device 50 is arranged on the driving device 30 and is configured for solidifying the material injected by the 3D printer 40. Each of the at least one solidifying device 50 is arranged slanted relative to a central axis of the printing head 42. In this situation, light rays 52 emitting from the solidifying device 50 are also slanted relative to a central axis of the printing head 42, and the light rays arrive directly to the material injected from the printing head 42, thereby solidifying the material injected from the printing head 42 quickly.

The container 60 is configured for receiving material for printing the microstructures 300, and the container 60 is connected with the 3D printer 40 via a flexible tube 62. In the illustrated embodiment, the container 60 further includes a measure unit 64. The measure unit 64 includes a sensor and the sensor is configured to pre-measure an amount of material and transmit the pre-measured material to the 3D printer 40. In this way, the printing head 42 only loads a certain amount of material, for example, the amount material is configured for forming one layer of microstructures 300, thus, avoiding the use of too much material which can affect the sensitivity of the print head 42.

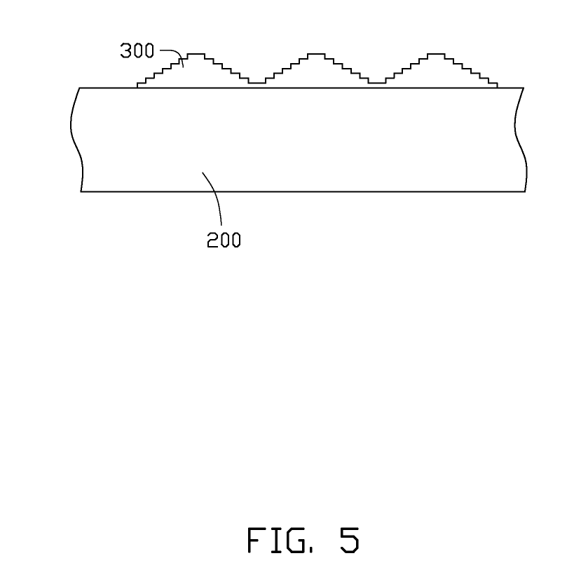

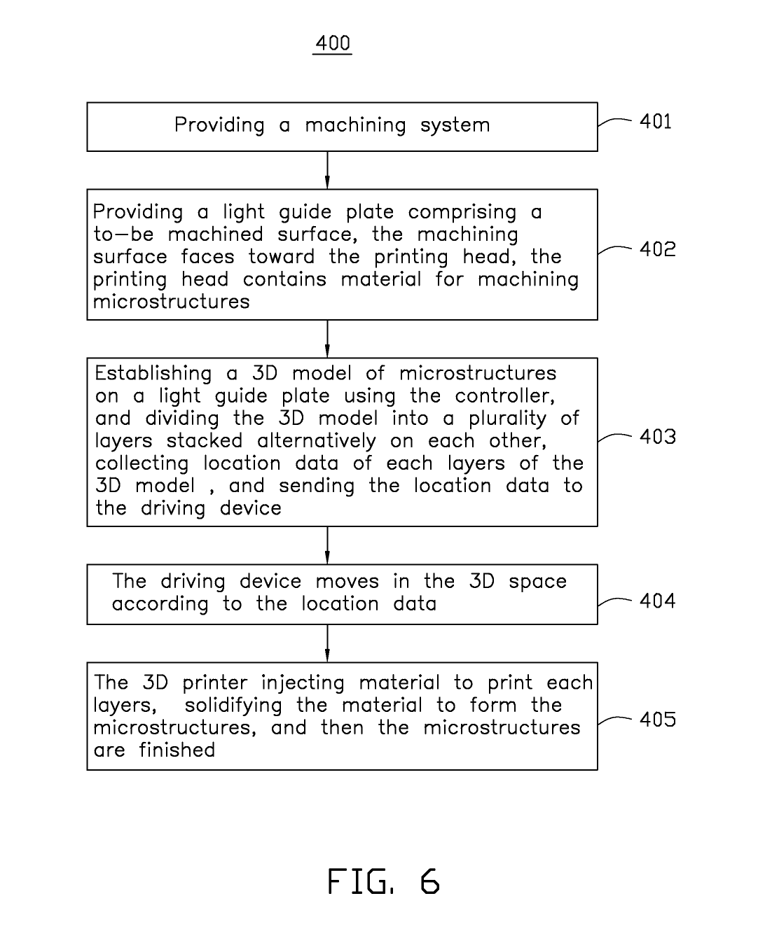

FIG. 6 illustrates a flowchart presented in accordance with an example embodiment. The example method 400 for manufacturing microstructures 300 on the light guide plate 200 (shown in FIG. 5) is provided by way of an example, as there are a variety of ways to carry out the method. The method 400 described below can be carried out using the configurations illustrated in FIG. 1, for example, and various elements of these figures are referenced in explaining the method 400. Each block shown in FIG. 6 represents one or more processes, methods or subroutines, carried out in the method 400. Additionally, the illustrated order of blocks is by example only and the order of the blocks can change according to the present disclosure. The method 400 can begin at block 401.

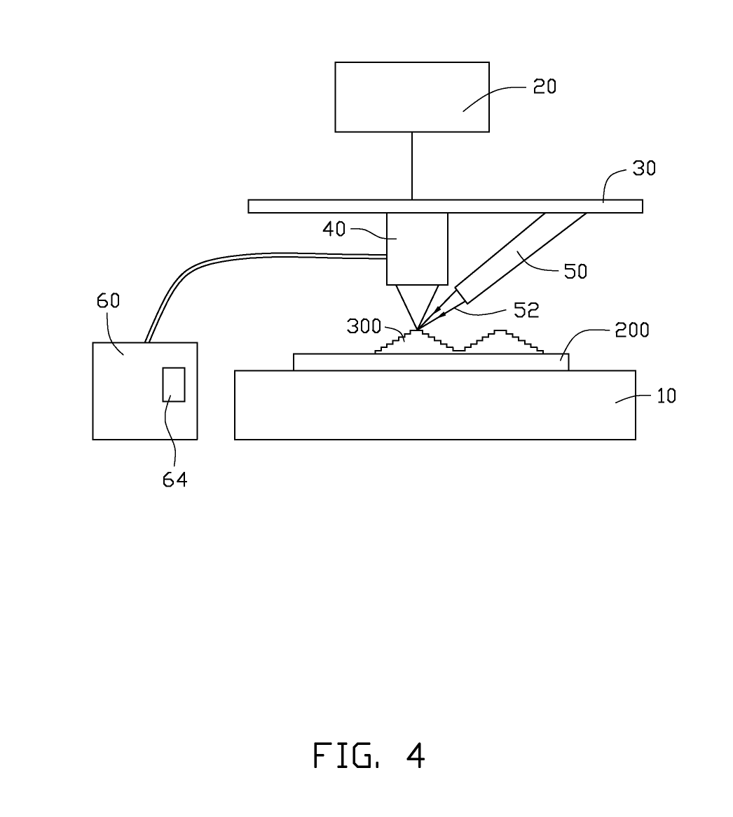

At block 401, a machining system 100 as mentioned in FIG. 1, is provided. FIGS. 4-5 illustrate that material for manufacturing the microstructures 300 are received in the container 60. The material is select from a group of UV glue, polymethylmethacrylate (PMMA), polycarbonate (PC) and polyethylene terephthalate (PET). In one embodiment, the material is UV glue, and the solidifying device 50 is an UV solidifying device. A refractive index of the material used for forming the microstructures 300 is the same as or similar to a material of the light guide plate 200, which can stop the microstructures 300 from absorbing light entering the light guide plate 200.

At block 402, a light guide plate 200 including a to-be-machined surface 201, as shown in FIG. 2, is provided. The machining surface 201 faces toward the printing head 42. The printing head 42 also contains material for machining the microstructures 300, material in the container 60 is suctioned into the printing head 42 by a pump (not shown).

At block 403, a 3D model 70 of microstructures 300 on the light guide plate 200 is established using the controller 20, and the 3D model 70 is divided into a plurality of layers 71,72 stacked alternatively on each other, location data of each layer 71,72 of the 3D model is captured, and is sent to the driving device 30. The shape of the microstructures' cross-section is circular or V-shaped. In the illustrated embodiment, each of the layers 71 and 72 has the same thickness and is divided into a plurality of segments 710. The controller 20 is configured for obtaining 3D coordinates of each small fragment of data.

At block 404, the 3D printer 40 is driven to move with the driving device 30, three dimensionally according to the location data.

At block 405, material is injected to print microstructures 300 on the to-be-machined surface 201 by the 3D printer 40, when the lower layer 71 is formed, the driving device 30 can move in a vertical direction away from the platform 10 to form an upper layer 72, until a shape of the microstructures are the same as the 3D model, at the same time, the microstructures 300 are solidified by the solidifying device 50. In this way, the material from the printing head 42 is timely solidified, this can avoid deformation of the lower layer 71.

In summary, as mentioned above, the microstructures on the light guide plate are formed using the 3D printer, thereby, having a free choice of the materials, and no mold design for the microstructures is needed, thus, saving time and reducing the cost of the mold development.

The embodiments shown and described above are only examples. Many details are often found in the art such as other features of a protection system and protection method. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A machining system for machining microstructure on a light guide plate comprising:
a platform configured for supporting a light guide plate;
a controller configured for establishing a 3D model for microstructures on the light guide plate;
a driving device configured for moving in three-dimensional space and electrically by the controller;
a 3D printer is fixed on the driving device, and driven by the driving device, the 3D printer is configured for accommodating material and configured for printing microstructures on the light guide plate according to the 3D model; and
at least one solidifying device is arranged on the driving device and configured for solidifying the material injected by the 3D printer.

2. The machining system of claim 1, wherein further comprises a container configured for receiving a material for printing the microstructures, and the container is connected with the 3D printer via a flexible tube.

3. The machining system of claim 2, wherein the container further comprises a measure unit, the measure unit is configured for measure a pre-amount material and transports the pre-amount material into the 3D printer.

4. The machining system of claim 1, wherein the 3D printer comprises a printing head in vertical direction, a light ray from the solidifying device is slanted relative to the printing head, and the light ray is able to arrive at the material injected from the printing head.

5. A method for machining microstructures on a light guide plate, the method comprising:
providing a machining system;
providing a light guide plate comprising a to-be-machined surface, and the to-be-machined surface faces toward the printing head, the printing head contains material for machining the microstructures;
establishing a 3D model of microstructures on a light guide plate using the controller, and dividing the 3D model into a plurality of layers stacked alternatively on each other, capturing a location data of each layers of the 3D model, and sending the location data to the driving device;
turning on the driving device, and the driving device moves in the three-dimensional space according to the location data,
turning on the 3D printer, the 3D printer injecting material to prints each layers,
solidifying the material to form the microstructures, and then the microstructures are finished.

6. The method of claim 5, wherein the material is select from UV glue, polymethylmethacrylate, polycarbonate or polyethylene terephthalate.

7. The method of claim 5, wherein the shape of the microstructures cross-section is circular.

8. The method of claim 5, wherein the shape of the microstructures cross-section is V-shaped.

9. The method of claim 5, wherein the machining system further comprises a container configured for accommodating a material for printing the microstructures, and the container is connected with the 3D printer via a flexible tube, the material is pumped into the printing head.

10. The method of claim 9, wherein the container further comprises a measure unit, the measure unit is configured for measure a pre-amount material and transports the pre-amount material into the 3D printer.

11. The method of claim 5, wherein the 3D printer comprises a printing head along vertical direction, a light ray from the solidifying device is slanted relative to the printing head, and the light ray is able to arrive at the material injected from the printing head.

12. The method of claim 5, wherein each of the layers is divided into a plurality of segments, the controller is further configured for obtaining 3D coordinates of each the fragments.

13. A microstructure manufacturing system comprising:
a platform for supporting a light guide plate;
a controller;
a driving device electrically controlled by the controller;
a 3D printer attached to the driving device for manufacturing microstructures on a light guide plate supported by the platform; and
at least one solidifying device for solidifying the microstructures manufactured by the 3D printer.
